(19) United States
(12) Patent Application Publication
(10) Pub. No.: US 2024/0289382 A1
(43) Pub. Date: Aug. 29, 2024

(54) Fuzzy-Neuro Case-Based Approximate Reasoning System and Method

(71) Applicant: Happy Hour At Home, Inc., San Juan, PR (US)

(72) Inventors: James P. Duffy, Hamilton, NJ (US); Howard r. Duffy, Hamilton, NJ (US)

(73) Assignee: Happy Hour At Home, Inc., San Juan, PR (US)

(21) Appl. No.: 18/572,969

(22) PCT Filed: Jun. 21, 2022
(86) PCT No.: PCT/US2022/034320

§ 371 Date: Dec. 21, 2023

Related U.S. Application Data
(60) Provisional application No. 63/212,956, filed on Jun. 21, 2021.

(51) Int. Cl. G06F 16/78; G06F 16/735

(52) U.S. Cl. CPC G06F 16/7867; G06F 16/735

(57) ABSTRACT

Aspects of the disclosure provide for tracking and analyzing data for user engagement of a library of content. Aspects of the disclosure provide for utilizing the tracked data more accurately to generate content rankings and recommendations, thereby improving the functionality of a system configured to provide the same. The platform can improve the reliability of metrics quantifying user engagement of hosted content, through the use of an approximate reasoning system tuned for analyzing user consumption of content with a length on the order of minutes and hours, not seconds. Current online video “viewability” standards do not address the vagueness and uncertainty of hot fraud; video viewed to completion; audio on while video viewed to completion; verifying user identity; verifying viewer legal drinking age if alcohol is involved; and a time-date stamped signature from the tagged video to provide trust, transparency, and auditable accountability.

### CROSS-REFERENCE TO RELATED APPLICATION

This application claims the benefit of the filing date of U.S. Patent Application No. 63/212,956 for FUZZY-NEURO CASE-BASED APPROXIMATE REASONING SYSTEM AND METHOD, which was filed on Jun. 21, 2021, and which is incorporated herein by reference.

### BACKGROUND

Online platforms provide an interface between providers of educational content, such as audio-visual media, and users of the platform that consume the content. Audio-visual media for educational content is often longer and more in-depth in the presentation of the subject content of the media, versus other forms of media content created for recreational or advertising purposes. For example, educational content is presented in the order of minutes or hours, whereas other forms of content may only be seconds long.

### BRIEF SUMMARY

Aspects of the disclosure provide for tracking and analyzing data for user engagement of a library of content. Aspects of the disclosure provide for utilizing the tracked data to more accurately generate content rankings and recommendation to improve the functionality of a system configured to provide the same. The platform can improve the reliability of metrics quantifying user engagement of hosted content through an approximate reasoning system tuned for analyzing user consumption of content with a length on the order of minutes and hours, not seconds. Current online video “viewability” standards do not address the vagueness and uncertainty of bot fraud; video viewed to completion (or not viewed to completion); audio on while video viewed to completion (or if video watched with audio muted); verifying viewer identity; verifying viewer legal drinking age if alcohol is involved (or if viewer is underage); and a time-date stamped signature from the tagged video to provide trust, transparency and auditable accountability.

Aspects of the disclosure can provide for A method for identifying domain expert videos, the method comprising: tagging, by one or more processors, data corresponding to the viewing of a video by a user; determining, by the one or more processors, that the user has satisfied a set of predefined events, based at least partly on the tagged data; after determining the user has satisfied the set of predefined events, associating the tagged data with a domain expert associated with the video; processing, by the one or more processors, the tagged data through a reasoning system to determine a set of weighted outcomes; and updating, by the one or more processors, a ranking list of domain expert videos based on the set of weighted outcomes.

Another aspect of the disclosure provides for a system for identifying domain expert videos, the system comprising one or more processors configured to: tag data corresponding to the viewing of a video by a user; determine that the user has satisfied a set of predefined events, based at least partly on the tagged data; after the determination that the user has satisfied the set of predefined events, associate the tagged data with a domain expert associated with the video; process the tagged data through a reasoning system to determine a set of weighted outcomes; and update a ranking list of domain expert videos based on the set of weighted outcomes.

Another aspect of the disclosure provides for one or more computer-readable storage media storing instructions, that when executed by one or more processors, cause the one or more processors to perform operations comprising: tagging, by one or more processors, data corresponding to the viewing of a video by a user; determining, by the one or more processors, that the user has satisfied a set of predefined events, based at least partly on the tagged data; after determining the user has satisfied the set of predefined events, associating the tagged data with a domain expert associated with the video; processing, by the one or more processors, the tagged data through a reasoning system to determine a set of weighted outcomes; and updating, by the one or more processors, a ranking list of domain expert videos based on the set of weighted outcomes.

These and other aspects can include one or more of the following features. In some examples, aspects of the disclosure provide for all of the features together, in combination.

The ranking list of domain expert videos is updated using a recurrent neural network trained to apply a take-the-best heuristic.

The set of predefined events comprises one or more of: the use of a bot filter while the user watches the video; the tagged video viewed to completion or not viewed to completion by the user; audio on while video viewed to completion, or if video watched with audio muted; verifying viewer identity; verifying viewer legal drinking age; and a time/date stamped signature from the tagged video.

Determining that the user has satisfied the set of predetermined events comprises binning values corresponding to the set of predetermined events through one or more fuzzy sets, each fuzzy set corresponding to a linguistic variable.

Processing the tagged data comprises processing the data binned values through a fuzzy controller comprising one or more knowledge bases to determine the set of weighted outcomes.

Each knowledge base corresponds to a respective domain, the tagged video corresponding to a domain.

Serving videos in response to a user request, wherein the videos served are in an order based on the updated ranking.

Measuring, by some measurement module, user interaction to determine for a plurality of events whether the events have occurred in the interaction of the user with the platform before, during and/or after the video is served, where a certain event corresponds to a certain type of user interaction, depending on the measurement result, determining for each measured user interaction a value assigned to a tag corresponding to the measured user interaction, wherein the value corresponding to a certain event is indicative of a partial degree of user interaction, wherein for non-binary measurement results the result of an interaction is binned into a set of fuzzy variables, the measurement results including a plurality of non-binary measurement results; feeding the tag values resulting from the measurement results to the reasoning system to determine a weighted outcome indicative of the overall degree of user interaction based on the combination of the tag values each representing a partial degree of user interaction; ranking a list of domain expert videos based on the resulting weighted outcomes of the respective videos; and updating the ranked list using a recurrent neural network trained to apply a take-the-best heuristic.

### BRIEF DESCRIPTION OF THE DRAWINGS

FIG. 1 is a block diagram of an example processing pipeline for processing a tagged video using a fuzzy-neuro case-based approximate reasoning system 100, according to aspects of the disclosure.

FIG. 2 depicts example case-based cases in an example knowledge base used by the fuzzy controller.

FIG. 3 depicts example entries of an example knowledge base maintained in the general ledger.

FIG. 4 depicts an example user report card.

FIG. 5 depicts an example domain expert report card.

FIG. 6 depicts an example leaderboard mapping data to ordered cues of the recommendation engine.

FIG. 7 is a flow diagram of an example process for content ranking using a Fuzzy-Neuro Case-Based Approximate Reasoning System, according to aspects of the disclosure.

FIG. 8 is a flow diagram of an example process for content ranking, according to aspects of the disclosure.

FIG. 9 is a block diagram of an example environment for implementing the system.

### DETAILED DESCRIPTION

### Overview

Aspects of the disclosure provide for a Fuzzy-Neuro Case-Based Approximate Reasoning System for addressing the deficiency in content engagement analysis for long-form educational content. Users of a platform desire to replicate the skills presented in educational content, which can include instructional or informative audio-video media, such as video tutorials. Educational content can include any form of audio-visual media on subjects across a variety of tacit knowledge domains. These video tutorials can include, for example, how to create different types of cocktails or how to create restaurant-quality meals at home, allowing users to learn skills without going through a professional or vocational school or program.

Other advantages are directed to improving user experience, particularly their tacit knowledge skill set. The tacit knowledge gap, e.g., knowledge generated by actively performing a task, instead of consuming content passively, can be reduced in users directed to ranked content. In turn, the barrier of entry to enter a domain introduced and taught by content in the ranked library, e.g., bartending, cooking, woodworking, etc., is reduced in users.

Tacit knowledge can be gained through observation, imitation, and practice. An online content platform as described herein can improve the quality of life for users, for example by facilitating their consumption of tacit knowledge to perform tasks that in turn can be performed by the user, to reduce their dependence on others to perform the same tasks, such as cook restaurant-quality food.

A platform as described herein can include a number of libraries organizing educational content according to different criteria, such as author, topic, degree of difficulty in learning the subject content, etc. For example, in a cocktail making video, a domain expert certified master bartender could teach users of a platform the tacit knowledge skill set of how to hold a bottle by the neck, how to pour a drink responsibly with a pour spout and jigger, how to shake a drink with two hands without the mixing glass and mixing tin falling apart, how to hold the mixing glass or mixing tin with a four-prong strainer in one hand when you strain the drink from the mixing glass/mixing tin into a cocktail glass, how-to salt the rim of a glass with either salt or sugar and how to cut the specific fruit needed to garnish the drink. Collectively, the user can observe, imitate, and practice the tacit knowledge techniques demonstrated in the educational content.

Current viewability standards applied as metrics for assessing user engagement in content have a number of shortcomings when applied to educational content. Online standards of viewability are measured in seconds, as opposed to minutes of time. Educational content can include videos typically ranging from between two and twenty minutes.

Current online video “viewability” standards also do not address at least the following criteria. Views and other forms of engagement from automated “bot users” instead of human users. Viewability standards do not track whether or not a view was or was not viewed to completion. Viewability standards also do not track the identity of the viewer (or whether the viewer is explicitly anonymous). Viewability standards also do not provide for a time-date stamped signature, to provide trust, transparency, and auditable accountability.

Unlike the traditional Bayesian Probabilities used with Bell Curve “Normal Distributions” aspects of the disclosure provide for a system that uses a combination of fuzzy logic, fuzzy sets, membership functions, a Fuzzy Control System, such as a Mamdani fuzzy controller, knowledge bases with case-based approximate reasoning (CBR) rules, defuzzified grade point averages and weighted outcomes, a recurrent neural network (RNN) using take-the-nest (TTB) heuristics to rank domain expert videos of content provided on an online platform. The rankings generated can be aggregated on an online leaderboard and used to inform recommendation engine users to receive recommendations for the content of domain expert videos ranked highest by the system.

The system can include an implicit or explicit rating system for users consuming content of the library to varying degrees. For example, the system may include a “badge” mechanism in which users are provided badges or other indications of predetermined achievements of certain activities on the platform, e.g., consuming a certain amount of content for a certain domain. User achievements and accomplishments may be tracked in a data structure such as a ledger.

User achievements can quantify the extent to which conjunctive events are met. As described herein, conjunctive events are conditions that may or may not be met, and whose combination of multiple positive occurrences of these events can produce a stronger indication of user engagement versus the presence of all or some of these events in isolation.

Example achievements include a viewer andragogy age-gate (minimum drinking age by jurisdiction), content viewed to completion or within a threshold completion, content viewed to completion with audio enabled.

Another achievement successfully using a bot filter by an objective third party. An example of bot filtration can be a captcha or other challenge meant to determine the authenticity of the user. Another example is user-certified identity through multi-factor authentication email confirmation. Another example is tagged video data document time/date stamp receipt

Points can be added for repeated activities, e.g., watching the same video to completion, with audio on. These and other factors can be represented in the system as a combination of binary and non-binary values. For instance, whether the age-gate was met, the bot filter was successful, the user provided identification, and time/date stamp receipt can be represented as binary values, indicating success or failure.

### Example Systems

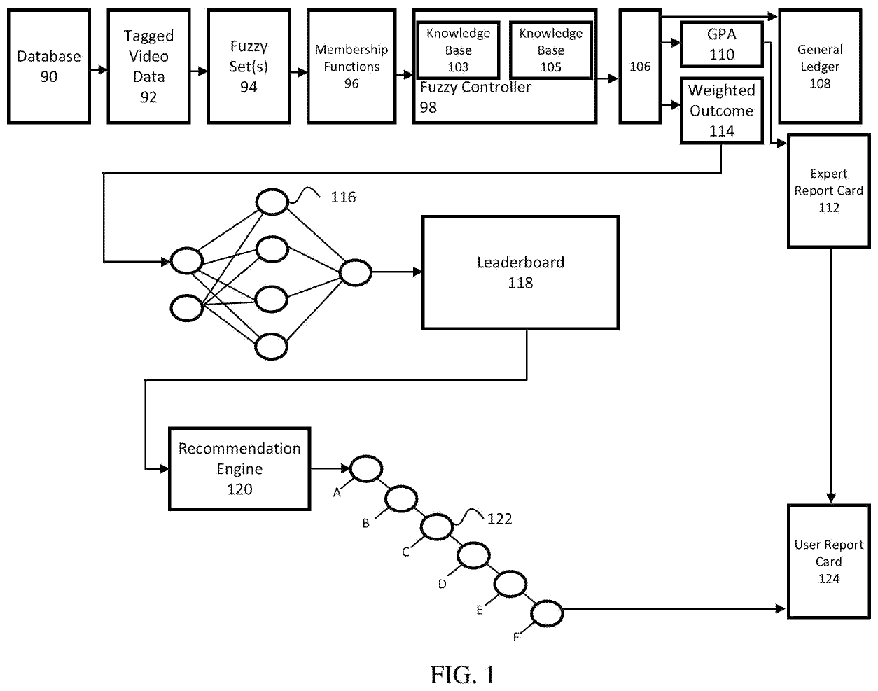

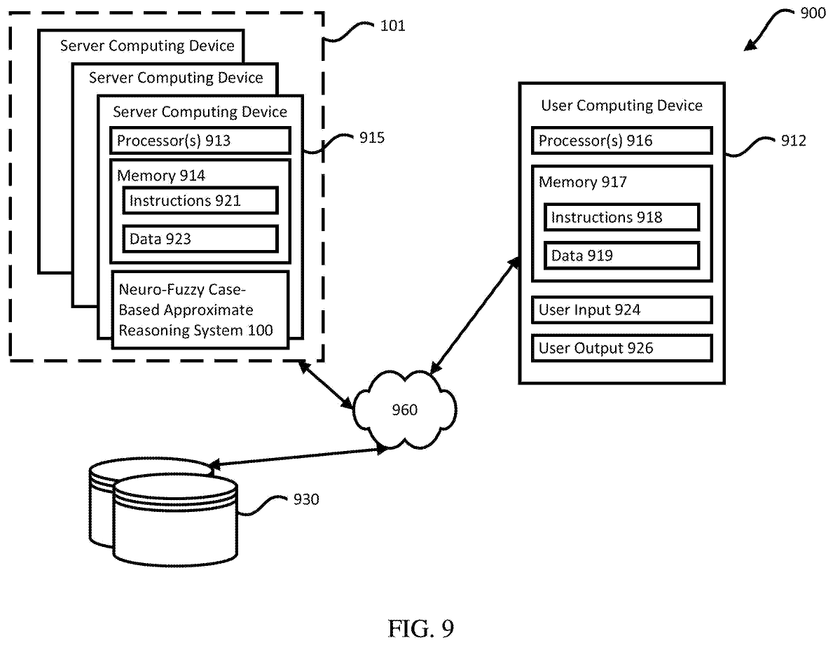

FIG. 1 is a block diagram of an example processing pipeline for processing a tagged video using a fuzzy-neuro case-based approximate reasoning system 100, according to aspects of the disclosure. The system 100 may be referred to as a ranking system. In some examples, an online platform 101 can at least partially implement the processing pipeline shown and described with reference to FIG. 1, over one or more processors in one or more physical locations. Example computing environments for implementing the platform are described with more detail with reference to FIG. 9.

The platform 101 maintains one or more libraries of education content in a database 90. Educational content can include any of a variety of different forms of content presented in digital audio-visual format, e.g., drawings, presentations, videos, sound clips, and livestreams. Some examples of educational content include “how-to” videos and “tutorial videos.” Although described as storing educational content, other forms of content, e.g., entertainment, advertisements, etc., may be stored and processed according to aspects of the disclosure. As described in more detail with reference to FIG. 9, the database 90 can be implemented according to a number of different technologies across one or more storage devices in one or more physical locations.

The system 100 tags content automatically in response to input requesting playback of content stored in the library, to generate an example tagged video data 92 from the database 90. For example, the system may receive a request to serve a video in response to a request generated by a computing device in response to user input. The user input can be received, for example, through user interaction with an interactable element, such as a play button corresponding to the playback of a video loaded on a website, desktop application, or mobile application. In some examples, playback and tagging may begin automatically when a web page and a video is loaded.

The system 100 can tag a video according to a number of different tags, which can measure some event that occurred in the interaction of the user with the platform before, during and/or after the video is served.

One example event can include the documentation 24 of the time/date stamp for when the video was accessed. Another example event can include the percentage of the video viewed 16. In this example, the percentage of the video viewed 16 can be relative to the total video running time, or TVRT, representing how long the video was running. The percentage of video viewed 16 can be measured, for example, based on how long at least a threshold portion of the video was on the screen of a user device while playing. In some examples, the event is measured with or without the inclusion of audio subtitles and/or closed captions.

Another example event 18 can include the percentage of audio that is on or unmuted while the video is playing. In some examples, the event is measured even if the audio is muted, but the video is played with subtitles and/or closed captions.

Another example event 22 can include whether the user in interacting with the platform 101 signed onto their account using multi-factor authentication.

Another example event can include whether video was played on a device in which bot filtering was enabled, e.g., to detect whether the video was being watched by a user versus an automated script or bot. Example mechanisms for bot filtering can include captchas or randomized questions or prompts that the user must answer while watching the video.

Another example event 14 can include whether user input was received to confirm that the user is above a certain age threshold for watching the educational content. For example, for educational content related to making alcoholic beverages, an age gate may be imposed in the form of a prompt, asking the user whether they are of legal drinking age in their jurisdiction.

The events 14-24 tagged can collectively be referred to as conjunctive events. The conjunctive events 14-24 are predetermined to be most indicative of a video engaging for passing on tacit knowledge to a user viewing the video. The occurrence of conjunctive events together may be more indicative of user engagement and the success of a video in passing on tacit knowledge to the user, than the occurrence of the separate events, in isolation to one another. Although six conjunctive events are described as examples throughout this specification, more or fewer conjunctive events may be used, and different domains may be associated with different conjunctive events for evaluating user engagement with corresponding educational content in the different domains.

One challenge in evaluating tagged video data against the occurrence or non-occurrence of conjunctive events is the rate at which potential combinations of tags on video data can increase exponentially with more events and/or more possible values describing each event. Although some conjunctive events may be binary, e.g., 0 or 1 depending on whether or not, for example, the user opted-in to multi-factor authentication or successfully passed an age-gate for some age-restricted content, the occurrence of other conjunctive events can be represented over a range of possible values.

For example, one example conjunctive event 16 is the percentage of the video the user was found by the system 100 to have watched. This percentage can be expressed from 0-100%, corresponding to over one hundred potential values. In combination with other non-binary conjunctive events, the total number of possible combinations becomes increasingly larger. In one example, the total number of the six conjunctive events 14-24 with limited percentile values, e.g., 0%, 25%, 50%, 75%, or 100%, can result in 400 possible combinations alone.

The potential combinations may be statistically skewed against favoring combinations that are indicative of positive user engagement with a video or other educational content. For instance, given a distribution of combinations to match a thirteen-letter grading system, e.g., including “A+” “A” “A−” “B+” “B” “B−” “C+” “C” “C−” “D+” “D” “D−” and “F” at an average of approximately 3 percent each. Depending on the minimum thresholds imposed for satisfactory user engagement based on the tagged video data and the occurrence or non-occurrence of the conjunctive events can result in a larger percentage of the possible combinations being rated as a failure or “F”. This distribution is a skewed distribution, also referred to as a power law curve.

The large range of potential combinations introduces vagueness and uncertainty in inferring whether the tagged video data is indicative of a positive user engagement with the subject video. While combinations towards the fringes of the range, e.g., zero watch time with audio on versus 100% watch time with audio on, can be used to infer the nature of the engagement of the user with the content, the many potential combinations within the range presents a challenge in identifying the level of user engagement. As a result, identifying videos in the database 90 that are more likely to engage users who have not yet seen the videos is more difficult, as well as ranking the videos produced by domain experts or authors.

Aspects of the disclosure address the issue of exploding possible combinations and skewed distributions through a combination of fuzzy logic, fuzzy sets, membership functions, a fuzzy control system, e.g., a Mamdani fuzzy control system, knowledge bases with case-based approximate reasoning rules, defuzzified grade point averages and weighted outcomes, and a recurrent neural network using take-the-best heuristics to rank educational content by identifying domain experts authoring content that improves user engagement.

A processing pipeline as shown and described with reference to FIG. 1 can be used to reduce processing from having to evaluate all possible combinations of conjunctive events in tagged video data, to instead group similar combinations and compare them to representative cases of user engagement. The representative cases can be a fraction in volume compared to the total number of possible combinations and can be selected by the system 100 to more efficiently, e.g., with fewer processing cycles or less wall-clock time, than existing approaches. The cases can correspond to different possible combinations of values for the conjunctive events, to allow for faster comparison and ranking as new tagged video data is received by the system.

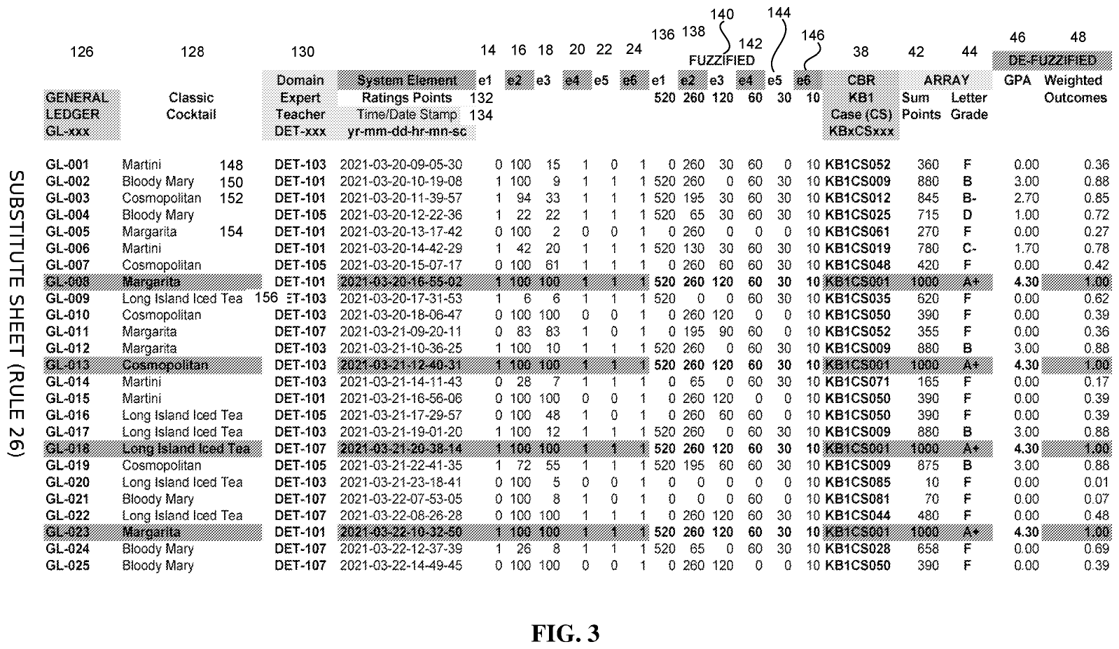

The system can maintain one or more fuzzy sets 94 for binning the tagged video data 92 to one of the bins with some probability. In this context, a fuzzy set can refer to a data structure storing information about software objects, such as those representing videos of the database 90, that are considered members of the fuzzy set. Each fuzzy set can correspond to a linguistic variable, in which an object is grouped according to the degree at which a logical proposition that can be answered by the linguistic variable is true for the object. The system 100 generates a membership value for the tagged video data 92, quantifying the degree at which the tagged video data 92 is indicative of conditions that make the proposition of the fuzzy set true. The system is configured to map fuzzy sets 94 and membership functions 96 to tagged video data. The generated mappings can be stored in a general ledger 108, described in more detail with reference to FIG. 3. Mappings can be generated for each tag applied to the tagged video data 92.

Factual information can be mapped onto a linguistic variable in a process referred to as fuzzification. De-fuzzification can refer to the process by which a fuzzy value is converted into a numerical value. Multiple objects in the same fuzzy set can be mapped to the same numerical value.

For example, as described herein, tagged video data 92 can be tagged with a percentage indicating how much of the tagged video was watched by a given user, relative to a total video running time of the video. A fuzzy set can correspond to the proposition of whether the user satisfied a condition of having viewed the video based on the tagged data.

If the tagged video is viewed between 0% and 12% of the Total Video Running Time (TVRT), then it is mapped to the fuzzy set “Definitely Not” and assigned a membership function value of “0”. If the tagged video is viewed between 13% and 37% of the TVRT, then it is mapped to the fuzzy set “Very Unlikely” and assigned a membership function value of “0.25”. If the tagged video is viewed between 38% and 62% of TVRT, then it is mapped to the fuzzy set “Maybe” and assigned a membership function value of “0.5”.

If the tagged video is viewed between 63% and 99% of the TVRT, then it is mapped to the fuzzy set “Very Likely” and assigned a membership function value of “0.75”. If the tagged video data 92 is viewed for 100% of the TVRT, then the system 100 tags the tagged video data 92 to the fuzzy set “Definitely” and assigns a membership function value of “1”.

As another example, a tagged video can be tagged with a percentage indicating how long audio was unmuted while the tagged video was playing for a given user, relative to the total video running time. If a Video is Viewed with the audio and between 0% and 12% of the TVRT, then it is mapped to the fuzzy set “Definitely Not” and assigned a membership function of “0”. If a video is viewed with the audio on between 13% and 37% of the TVRT, then it is mapped to the fuzzy set “Very Unlikely” and assigned a membership function value of “0.25”. If a video is viewed with the audio on between 38% and 62% of the TVRT, then it is mapped to the fuzzy set “Maybe” and assigned a membership function of “0.50”. If a Video is viewed with the audio on between 63% and 99% of the TVRT, then it is mapped to the fuzzy set “Very Likely” and assigned a membership function value of “0.75”. If a Video is viewed with the audio on for 100% of the TVRT, then it is mapped to the Fuzzy Set “Definitely” and assigned a membership function of “1”.

Although examples of thresholds for each fuzzy set and membership function values are provided, it is understood that the thresholds and membership functions values can vary for the fuzzy sets 94 and the membership functions 96 from example-to-examples. The thresholds and/or membership function values can be tuned, e.g., automatically or through manual adjustment, for example driven by empirical study of the behavior of the system under different thresholds.

As described herein, the platform 101, for example separate from or in conjunction with the system 100, can process tagged video data to generate achievement and certification data for a user represented in the data. Achievement data can refer to one or more internal or user-facing achievements indicating the satisfaction of one or more conditions associated with the achievement. In some examples, achievements can be part of a tier, for example a “bronze” tier below a “silver” tier, below a “gold” tier representing achievements with gradually more difficult conditions for a user to meet.

Certification data can include certificates representing the completion of one or more videos or other audio-video content on the platform 101. For example, the platform 101 may be configured to award users who complete a predetermined sequence of videos on how to make classic cocktails with a corresponding certificate, which may be displayed on a user profile page or associated with an account on the platform 101 for the user.

The general ledger 108 can maintain a domain expert teacher evidentiary report card 112 (“report card 112”) for multiple different teachers authoring content which is consumed by users of the platform. The report card 112 can include achievement and certificate data for different users who have been identified by the system 100 as meeting the corresponding conditions for earning the achievements and/or certificates, while watching a video authored by a teacher represented by the report card 112.

The platform 101 can automatically check and apply conditional logic to determine whether a user may be awarded an achievement or a certificate. For example, the platform 101 can determine whether a user logged into an account using multi-factor authentication (“opt-in” event 22) and whether the user acknowledged that they meet the age-gate criteria, (“age-gates” event 14). Then, in addition to some or all of the other events described herein occurring, e.g., events for documenting time/date stamp 24, percentage of video viewed 16, percentage of audio on during video 18, and video bot filter 20 being active, the platform 101 can award an achievement, such as “bronze badge” for meeting these minimum conditions.

As another example of an achievement awarded by the platform 101, in addition to the conditions described above for awarding a “bronze badge,” the platform 101 can check for the satisfaction of additional conditions to potentially award the user with a higher-tier achievement. For example, the platform may check for multiple instances of completion of the events corresponding to the video tags by a user. For example, the platform 101 can determine whether the user viewed the video a second time to completion, with the audio on, and bot filter enabled, and awarded a higher-tiered achievement, such a “silver badge.” In another example, even further multiple re-watchings can result in even higher tier achievements, e.g., a “gold badge.” The exact achievements, tiers, and conditions for meeting those tiers can vary from example-to-example.

In some examples in addition to or as an alternative to the examples presented herein, the platform can issue a scoring system for providing points or some other numerical measure to value the completion of certain events by a user with respect to a video, to varying degrees. For example, conjunctive events tracked using video tags may each be associated with a point value that collectively adds up to a maximum number, e.g., 1000 points.

In one example, 520 points may be awarded by the platform for positive age-gating of the user for content with age restrictions, such as content related to alcohol; 260 points may be awarded for a video viewed to completion; 120 points may be awarded for a video viewed to completion with audio on (or, in some examples, if the audio is muted but the video is played with subtitles and/or closed captions); 60 points may be awarded for the use of a video bot filter (optionally, with documentation); 30 points may be awarded for user opt-in of multi-factor authentication to verify their identity; and 10 points may be awarded for tagged video data documented with time/date stamp receipt.

After awarding the points, the platform 101 can add up and determine whether the user meets the criteria, e.g., minimum point thresholds, for being awarded one or more achievements and/or a certificate for completing the video.

The issuance of a certificate to a user by the platform 101 may or may not be related to conditions for certain tiers of achievements awarded to a user. For example, the platform may issue a certificate to users who achieve the “gold badge” tier of achievement, associating the certificate with the account of the user.

Fuzzy Controller 98 applies case-based reasoning to process the generated fuzzy sets 94 and membership functions 96. Case-Based reasoning can be referred to as the process of solving new problems based on the solutions of similar past problems. For example, the fuzzy controller can be a Mamdani fuzzy control system, with a rule base implementing two principles of fuzzy control, retrieve and reuse. Under retrieve, the fuzzy controller 98 retrieves from memory one or more representative cases previously collected into one or more knowledge bases. Each knowledge base includes tagged video data corresponding to a respective domain, e.g., cocktail making, woodworking, etc.

The tagged video data in the knowledge base can represent a number of different cases, in which the user engagement is quantified and provided as a weighted outcome. For example, an example case may have a particular combination of values for the conjunctive events and be associated with high user engagement, indicated by a corresponding labeled weighted outcome. The labeled weighted outcome may be a grade letter and/or be scored against the ratings point scale, as described herein with respect to the achievement and certificate data. The weighted outcome may be a value, e.g., a numerical value akin to a grade-point average, for example from 0 to 4.3. Example knowledge bases 103 and 105 are illustrated, but it is understood that the fuzzy controller 98 can maintain any number of knowledge bases from example-to-example.

As part of generating the weighted outcomes, the fuzzy controller 98 can use the ratings points generated for each tagged video data. The fuzzy controller can apply predetermined values corresponding to each fuzzy set, so that values for each predetermined event binned in the same fuzzy set are assigned the same value. From the ratings points, the fuzzy controller “defuzzifies” to calculate the weighted outcome. The fuzzy controller can, for example, apply a predetermined formula for converting the ratings points to a weighted outcome, e.g., a function of the ratio between the number of points assigned and the total number of points. The allocation of ratings points can vary for different knowledge bases, e.g., different point values for different conjunctive events. The fuzzy controller 98 can defuzzify the ratings points to generate a corresponding grade-point average from the ratings points. Defuzzification 106 is shown as performed outside of the fuzzy controller 98, although it is understood that the fuzzy controller 98 itself can perform the defuzzification as described here.

The use of cases by the fuzzy controller 98 reduces computational resources, e.g., processing clock cycles and memory usage, over approaches in which each potential combination is labeled and compared against input-tagged video data. The retrieved cases may be reused by the fuzzy controller to map the solution, e.g., the weighted outcome of the retrieved case, to newly received tagged video data. For example, the fuzzy controller 98 can compare the fuzzy sets in which input-tagged video data is binned to, against the several representative cases of a knowledge base. Based on the representative case closest to the received tagged video data, the fuzzy controller 98 can output a weighted outcome 114 quantifying the user engagement indicated by the tagged video data. The achievement and certificate data can be additional features that are processed through the fuzzy controller 98.

The RNN 116 can be trained to rank domain expert videos, using input data, which can also include weighted outcomes 114, as well as generated achievement and certificate data, and the tagged video data. The RNN 116 can be trained to weigh more favorably rankings based on a take-the-best (TTB) heuristic. Under TTB, a selection between two choices is made based on the difference of a single feature, as opposed to looking at all of the features, together. To promote the application of TTB, during training, the RNN 116 can be rewarded with a higher weight for rankings applying TTB reasoning, for example by ranking videos with higher tagged video watch completion over videos with lower tagged video watch completion.

In some examples, the output of the RNN 116 can be a ranking score, which can be used to compare with other videos having predicted ranking scores, to then sort the videos according to the predicted ranking score.

In some examples, to initialize the system, videos for different domain experts are posted to the platform 101 for generating an initial ranking, based on some predetermined characteristics, such as initial viewership count. In some examples, the initial ranking is randomized.

The RNN 116 can repeat the training step multiple times, until meeting one or more stopping criteria. The stopping criteria can include, for example, a maximum number of training steps and/or, for supervised learning, iterations of backpropagation, gradient descent, and model parameter update. The stopping criteria can additionally or alternatively define a minimum improvement between training steps.
an example objective function can be a relative or absolute reduction in the computed error between output predicted by the RNN 116 and corresponding ground-truth labels on training data reserved for validation. An objective function that can be used is evaluating how close a correct ranking predicted by the RNN 116 is versus a ground-truth ranking, e.g., how many videos are in the correct order and position relative to one another.

In some examples, the RNN 116 can be trained for multiple epochs with early stopping where a validation error is not improved for 10 epochs. Other stopping criteria can be based on a maximum amount of computing resources allocated for training, for example a total amount of training time exceeded, or total number of processing cycles consumed, after which training is terminated. By consolidating the possible combinations of conjunctive events using the fuzzy controller 98, aspects of the disclosure provide for reducing the amount of training data needed overall for training the RNN 116. This, in turn, can improve the processing of the platform 101, at least because the identification and ranking of domain expert videos can be performed more efficiently, e.g., in fewer processing cycles and/or wall-clock time. Further, the processed fuzzy sets can represent a distillation of the larger set of raw data, which can be processed more efficiently over approaches in which a neural network is responsible for feature extraction exclusively.

Although examples are described with reference to RNN, it is understood that other neural network architectures may be used. For example, the RNN may be unrolled and represented as a feedforward network. Specific types of RNNs, such as long short-term memory networks, long short-term memory networks (LSTMs), finite impulse RNNs, or infinite pulse RNNs, may be used. Another example class of neural networks that may be used include Feedback Neural Network (FNNs).

The weighted outcomes populate the leader board 118, and can be ordered using recommendation engine 120, e.g., by highest total score, per domain. The output of the recommendation engine 120, e.g., the domain expert data with their aggregated weighted outcomes, can be fed back into the platform 101. The platform 101 can use the weighted outcomes to preferentially serve content corresponding to higher-ranked domain expert videos over lower-ranked domain expert videos, which can improve overall user engagement and tacit knowledge serving.

In some examples, the system 100 may perform: measuring, by some measurement module, user interaction to determine for a plurality of events whether the events have occurred in the interaction of the user with the platform before, during and/or after the video is served, where a certain event corresponds to a certain type of user interaction, depending on the measurement result, determining for each measured user interaction a value assigned to a tag corresponding to the measured user interaction, wherein the value corresponding to a certain event is indicative of a partial degree of user interaction, wherein for non-binary measurement results the result of an interaction is binned into a set of fuzzy variables, the measurement results including a plurality of non-binary measurement results, feeding the tag values resulting from the measurement results to a reasoning system to determine a weighted outcome indicative of the overall degree of user interaction based on the combination of the tag values each representing a partial degree of user interaction, ranking a list of domain expert videos based on the resulting weighted outcomes of the respective videos; updating the ranked list using a recurrent neural network trained to apply a take-the-best heuristic.

The measurement of user interaction uses a technical means to determine the way and extent, to which a user interacts with the video. For that purpose, the user interaction has to be watched and monitored by some sensor or detection mechanism, thereby achieving the technical effect of detecting or “measuring” a physical interaction between the user and the device. This achieves the technical effect of the detection of “physical actions” by the user.

The conversion of the detected interactions or events into values representing the degree of user interaction further achieves the technical effect of processing such interactions to thereby affect the further operation of the overall system, which is a “technical effect” of the determination and processing of the user interaction.

The binning of non-binary values and their processing by a reasoning system reduces computation complexity of the processing of measurement values for the purpose of drawing conclusions. It thereby achieves the technical effect of increasing computational efficiency.

In some examples, the system 100 can be augmented through the implementation of a fast-and-frugal tree (FFT) over the predetermined conjunctive events represented in the tagged video data. A FFT implemented as a decision tree can have a root and multiple levels with binary decision points. At each level except the last level, there is one branch leading to an exit node, e.g., to end the decision process, and another branch advancing the decision process to the next level. At the last level, the FFT can have to exit nodes, such that the decision process regardless of which decision is made. In FIG. 1, an example FFT 122 is shown with six exit nodes A-F, each corresponding to a respective conjunctive event. The FFT 122 can act as a filter for populating a user report card 124. The user report card can keep records of instances in which the user was awarded one or more achievements and/or certificates by the system. The system can pass the entries of the report card to the report card 112 for the domain expert authoring the tagged video. The FFT 122 can quickly filter out entries in which at least one conjunctive event is not satisfied. One reason for the filter can be to focus on only entries that satisfy the predetermined criteria, which may be prioritized over other metrics or tags available in the tagged video data.

The branches in the FFT 122 may be ranked, for example by most important conjunctive event to least important conjunctive event. The ranking may be determined, for example, based on a numerical point value assigned to each event. In the example described herein, the event of the user watching through the whole video was weighted with the most points relative to the other events, therefore in some examples exit node A could be on a branch determining whether or not the user watched the tagged video to completion. In some examples, the system can apply FFT 122 to filter tagged video data before processing the data to determine whether to generate achievement and/or certificate data.

In some examples, all tagged data with maximum rating points and that pass the FFT 122 for all conjunctive events are posted to a user report card 124, which may be viewed online, e.g., through a web browser. Achievement and certificate data corresponding to the student can also be presented on user report 124. In some examples, some or all information posted to the user report card 124 may also be viewed on the domain expert report card 112 of the domain expert authoring the video watched by the user.

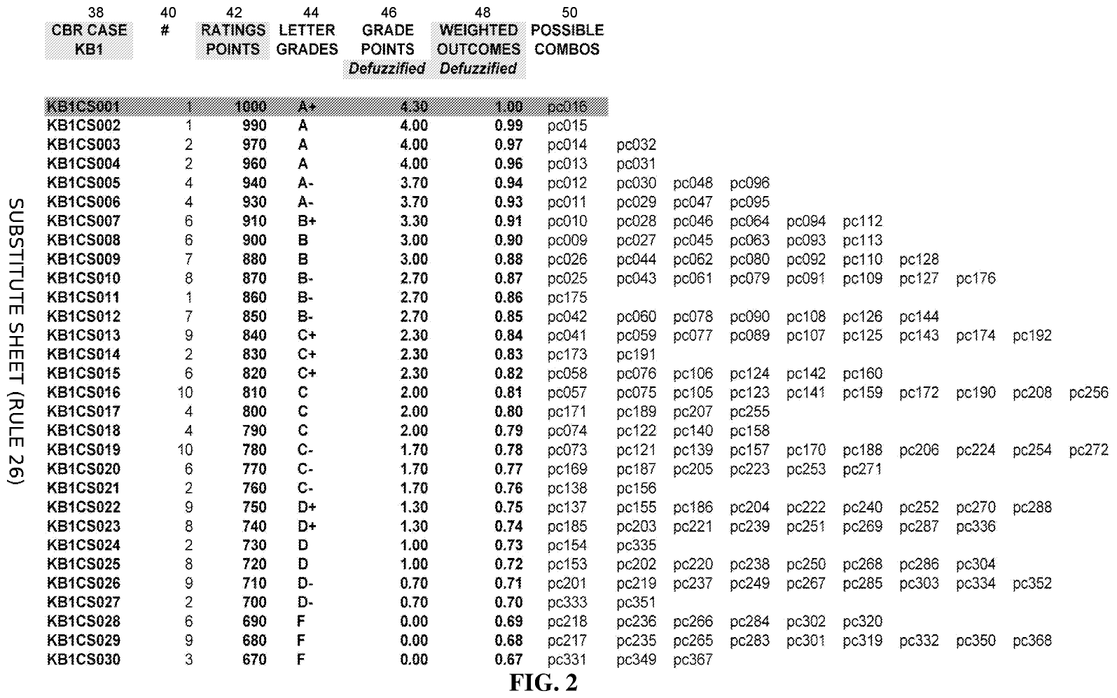

FIG. 2 depicts example case-based cases in an example knowledge base used by the fuzzy controller 98. Column 38 shows the case number for each case in the example knowledge base. Column 40 shows the number of possible combinations per case in the example knowledge base. Column 126 tracks individual ledger entries by unique identifier, e.g., GL-001, GL-002, etc. Column 42 shows the number of total ratings points corresponding to the conjunctive events occurring for each case. Column 44 is a column of letter grades mapped to the ratings points. Column for letter grades 46 shows the grade points defuzzified from the letter grades. Column for weighted outcomes 48 are the weighted outcomes defuzzified from the ratings points, using the fuzzy controller 98. Column 50 are possible combinations (“pc”) of the conjunctive events corresponding to each case.

FIG. 3 depicts example entries of an example knowledge base 701 maintained in the general ledger 108. The general ledger 108 can be a block chain or distributed data structure, either publicly viewed, e.g., through an external API, or private to a particular group or organization. In some examples, the general ledger 108 is centrally located on one or more servers hosting the ledger 108, which can include or be different from devices hosting the database 90.

Example knowledge base 701 corresponds to educational content related to making “classic cocktails,” as shown in column 128 with example entries such as Martinis, Margaritas, Long Island Iced Teas, etc. Column 130 tracks a domain expert or author of an educational video within the domain corresponding to the knowledge base 701. Row 132 tracks rating points provided after processing tagged video data as described herein, along with a column 134 tracking time/date stamps. Conjunctive events 14-24 are tracked by corresponding columns, marked e1-e6 after the reference numeral corresponding to a respective conjunctive event. Columns 136, 138, 140, 142, 144, and 146 each correspond to a respective conjunctive event 14, 16, 18, 20, 22, and 24, and track a point value assigned by the system 100 for each conjunctive event. Each point value is out of a respective maximum which together adds up to 1000, as in the example provided herein.

Column 38 tracks a respective case-based reasoning case number in the example knowledge base. As described herein, the knowledge bases of the fuzzy controller 98 uses a subset of cases relative to the total number of possible combinations of the conjunctive events 14-24. Column 42 shows the ratings points for each row in the knowledge base and column 44 shows the defuzzified grades corresponding to the ratings points in column 42. Column for weighted outcomes 48 shows the weighted outcome for each video shown in the rows.

As one example, row 148 tracks data generated for a tagged video about marking a martini. As another example, row 150 tracks data generated for a tagged video about making a bloody mary. As another example, row 152 tracks data generated for a tagged video about making a cosmopolitan. As another example, row 154 tracks data generated for a tagged video about making a margarita. As another example, row 156 tracks data generated for a tagged video about making a Long Island iced tea.

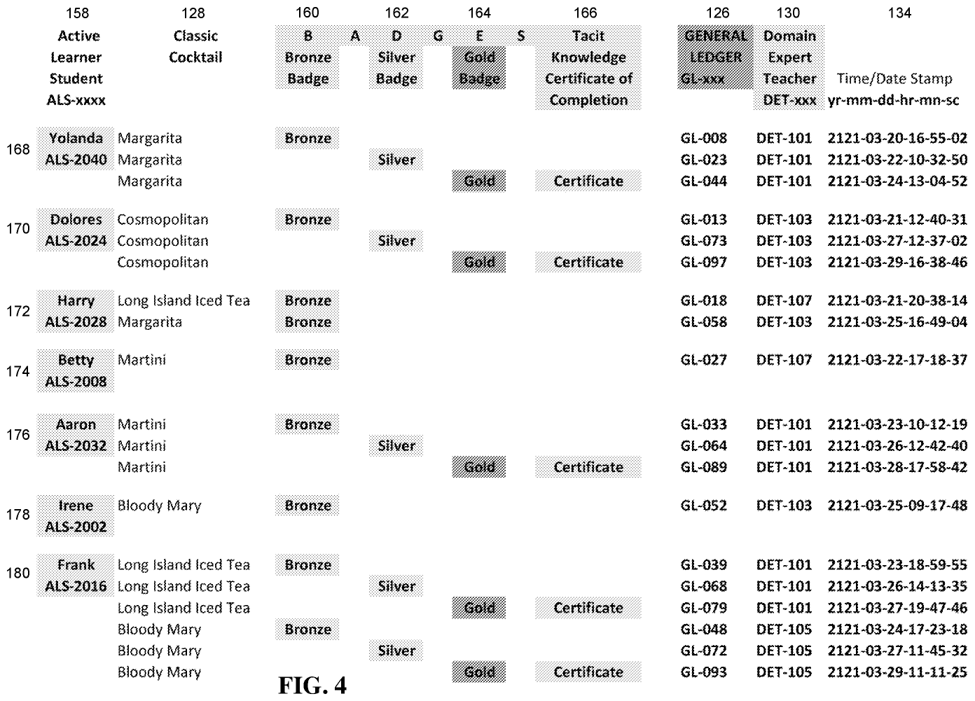

FIG. 4 depicts an example user report card. Column 158 tracks user identifiers, which can be provided automatically by the platform. Column 128 tracks classic cocktail names, which in this example can refer to subjects that each corresponding user has watched videos for. Achievements 160-164 are tracked, as well as whether the user earned a certificate 166. Column 130 tracks a domain expert identifier corresponding to the video watched by one of the users 168-180. Column 134 tracks the time/date stamp for each video interaction.

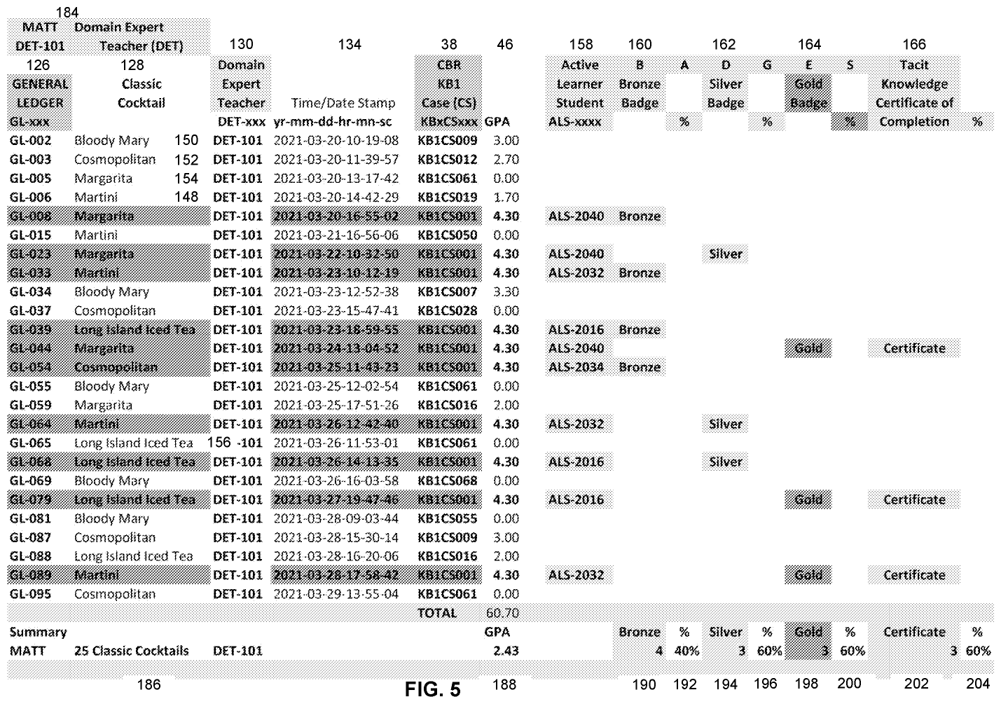

FIG. 5 depicts an example domain expert report card 184. Column 130 tracks the domain expert identifier, DET-101 in this case for a single domain expert. Column 134 is a time/date stamp column. Column 38 tracks knowledge base case identifiers. Grade-point averages 46 are shown in the next column. Column 158 tracks user identifiers for each entry. Achievements 160-164 are tracked, as well as whether the user earned a certificate 166.

Field 186 tracks the number of total cocktail videos for the domain expert. Field 188 tracks the overall grade-point average calculated from the videos for the domain expert. Field 190 tracks the number of “bronze medal” achievements earned by users having viewed videos by the domain expert. Field 192 is the percentage of “bronze medal” achievements by users from videos authored by the domain expert. Field 194 tracks the number of “silver medal” achievements earned by users having viewed videos by the domain expert. Field 196 is the percentage of “silver medal” achievements by users from videos authored by the domain expert. Field 198 tracks the number of “gold medal” achievements earned by users having viewed videos by the domain expert. Field 200 is the percentage of “gold medal” achievements by users from videos authored by the domain expert. Field 202 tracks the number of certificates earned by users having viewed videos by the domain expert. Field 204 is the percentage of certificates by users from videos authored by the domain expert.

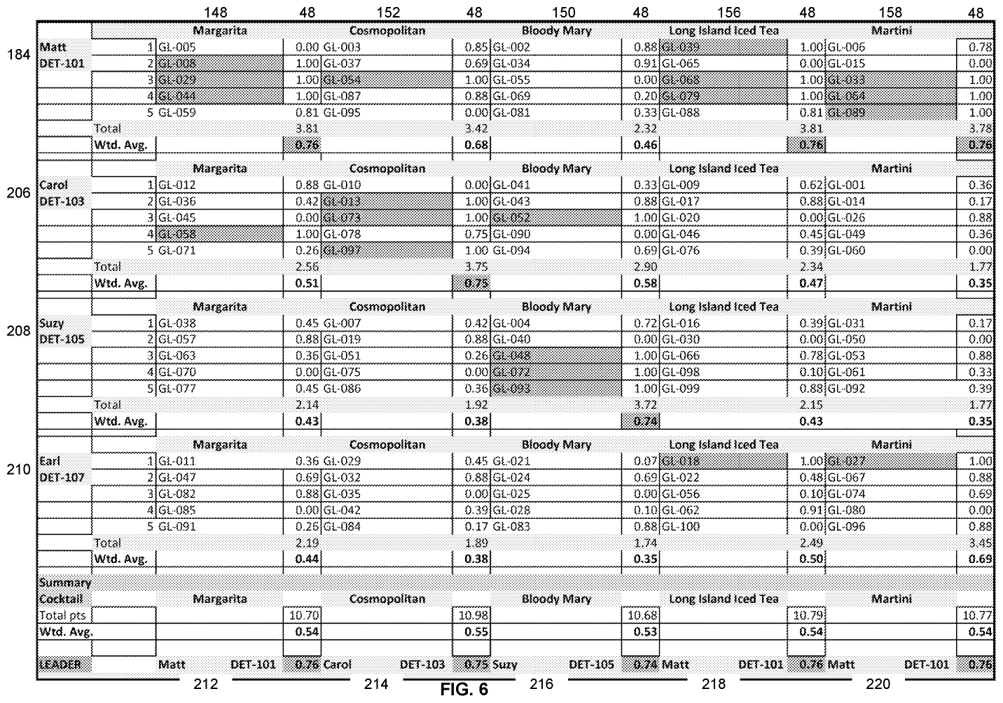

FIG. 6 depicts an example leaderboard mapping data to ordered cues of the recommendation engine. Leaders 212-220 show corresponding leaders for each type of beverage, margarita, cosmopolitans, bloody marys, long island iced teas, and martinis, respectively. Information for domain experts 184, 206, 208, and 210 are shown along each row. Columns 148, 152, 150, 156, and 154 show entries of tagged video data for each type of beverage, e.g., margarita, cosmopolitans, bloody marys, long island iced teas, and martinis. Weighted outcomes 48 are shown alongside each entry.

### Example Methods

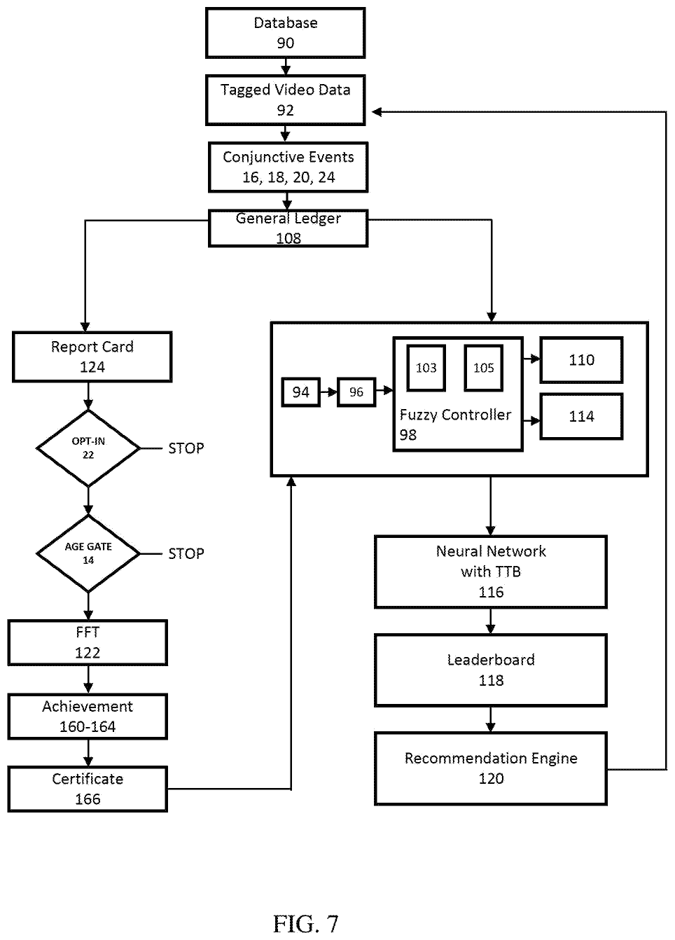

FIG. 7 is a flow diagram of an example process for content ranking using a Fuzzy-Neuro Case-Based Approximate Reasoning System, according to aspects of the disclosure.

From database 90, tagged video data 92 is received and checked for conjunctive events 16, 18, 20, and 24. The tagged video data can be stored in the general ledger 108, which may also include information in the user report card 124 and/or the domain expert report card 117. The system may check for satisfaction of the opt-in event 22 and/or the age-gate event 14, or otherwise STOP if not satisfied. The system can pass the tagged video data 92 through the FFT 122 to determine satisfaction of all conjunctive events. Based on at least the satisfaction of the conjunctive events, the user may be awarded an achievement 160. Further achievements and certificates 162-166 may be added subject to satisfaction of predetermined criteria, as described herein with reference to FIG. 1. The achievement and certificate data of the user can be added to the domain expert report card 112.

The video tagged data, achievement, and certificate data, and/or additional data from the domain expert report card 112 can be passed through the fuzzy sets 94, membership functions 96, and fuzzy controller 98, as shown and described with reference to FIG. 1. The output weighted outcomes can be processed through the RNN with TTB 116, to rank the domain expert videos. The results of the ranking can be posted to leaderboard 118, accessible by users of the platform.

Recommendation engine 120 can receive the ranked order of domain experts and can use the ranked order to provide recommendations and server query requests for content based to recommend higher-rated domain experts for a given domain over lower-rated experts.

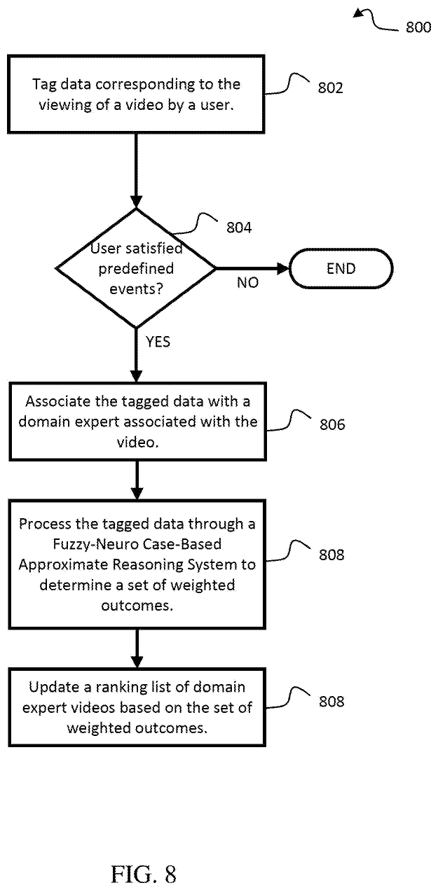

FIG. 8 is a flow diagram of an example process for content ranking, according to aspects of the disclosure.

The reasoning system tags data corresponding to the view of a video by a user, according to block 802. As shown and described with reference to FIGS. 1 and 7, the system or another engine, module, or device, can tag the video with signals received during the viewing of the video by the user. The data can be retrieved, for example, by the platform and/or by a user device displaying the video.

The reasoning system determines whether the user has satisfied a set of predetermined events, according to decision block 804. The predetermined events can be the conjunctive events described herein with reference to FIGS. 1, 7 and/or including different conjunctive events. In some examples, the system can determine whether the user has satisfied the set of predetermined events by processing the events through an FFT.

If the reasoning system determines that the user has not satisfied the set of predetermined events (“NO”) the process ends. Otherwise, the system associated the tagged data with a domain expert associated with the video, according to block 806. Data corresponding to the domain expert can be presented on a domain expert report card, and/or be used additionally in processing the tagged data through the Fuzzy-Neuro Case-Based Approximate Reasoning System to determine a set of weighted outcomes.

The reasoning system processes the tagged data through a Fuzzy-Neuro Case-Based Approximate Reasoning System to determine a set of weighted outcomes, according to block 808. In some examples, the ranking itself is a Fuzzy-Neuro Case-Based Approximate Reasoning System. For example, the system 100 as shown and described with reference to FIG. 1. In some examples, the reasoning system is a larger system that includes the system 100.

The system can update or generate a ranking list of domain expert videos based on the set of weighted outcomes. For example, the system can use a RNN with TTB trained to generate the ranking or update an existing ranking.

### Example Computing Environment

FIG. 9 is a block diagram of an example environment 900 for implementing the system 100. The system 100 can be implemented on one or more devices having one or more processors in one or more locations, such as in server computing device 915. User computing device 912 and the server computing device 915 can be communicatively coupled to one or more storage devices 930 over a network 960. The storage device(s) 930 can be a combination of volatile and non-volatile memory and can be at the same or different physical locations than the computing devices 912, 915. For example, the storage device(s) 930 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 915 can include one or more processors 913 and memory 914. The memory 914 can store information accessible by the processor(s) 913, including instructions 921 that can be executed by the processor(s) 913. The memory 914 can also include data 923 that can be retrieved, manipulated, or stored by the processor(s) 913. The memory 914 can be a type of non-transitory computer readable medium capable of storing information accessible by the processor(s) 913, such as volatile and non-volatile memory. The processor(s) 913 can include one or more central processing units (CPUs), graphic processing units (GPUs), field-programmable gate arrays (FPGAs), and/or application-specific integrated circuits (ASICs).

The instructions 921 can include one or more instructions that when executed by the processor(s) 913, causes the one or more processors to perform actions defined by the instructions. The instructions 921 can be stored in object code format for direct processing by the processor(s) 913, or in other formats including interpretable scripts or collections of independent source code modules that are interpreted on demand or compiled in advance. The instructions 921 can include instructions for implementing the system 100 consistent with aspects of this disclosure. The system 100 can be executed using the processor(s) 913, and/or using other processors remotely located from the server computing device 915.

The data 923 can be retrieved, stored, or modified by the processor(s) 913 in accordance with the instructions 921. The data 923 can be stored in computer registers, in a relational or non-relational database as a table having a plurality of different fields and records, or as JSON, YAML, proto, or XML documents. The data 923 can also be formatted in a computer-readable format such as, but not limited to, binary values, ASCII, or Unicode. Moreover, the data 923 can include information sufficient to identify relevant information, such as numbers, descriptive text, proprietary codes, pointers, references to data stored in other memories, including other network locations, or information that is used by a function to calculate relevant data.

The user computing device 912 can also be configured similar to the server computing device 915, with one or more processors 916, memory 917, instructions 918, and data 919. The user computing device 912 can also include a user output 926, and a user input 924. The user input 924 can include any appropriate mechanism or technique for receiving input from a user, such as keyboard, mouse, mechanical actuators, soft actuators, touchscreens, microphones, and sensors.

The server computing device 915 can be configured to transmit data to the user computing device 912, and the user computing device 912 can be configured to display at least a portion of the received data on a display implemented as part of the user output 926. The user output 926 can also be used for displaying an interface between the user computing device 912 and the server computing device 915. The user output 926 can alternatively or additionally include one or more speakers, transducers or other audio outputs, a haptic interface or other tactile feedback that provides non-visual and non-audible information to the platform user of the user computing device 912.

Although FIG. 9 illustrates the processors 913, 916 and the memories 914, 917 as being within the computing devices 915, 912, components described in this specification, including the processors 913, 916 and the memories 914, 917 can include multiple processors and memories that can operate in different physical locations and not within the same computing device. For example, some of the instructions 921, 918 and the data 923, 919 can be stored on a removable SD card and others within a read-only computer chip. Some or all of the instructions and data can be stored in a location physically remote from, yet still accessible by, the processors 913, 916. Similarly, the processors 913, 916 can include a collection of processors that can perform concurrent and/or sequential operation. The computing devices 915, 912 can each include one or more internal clocks providing timing information, which can be used for time measurement for operations and programs run by the computing devices 915, 912.

The server computing device 915 can be configured to receive requests to process data from the user computing device 912. For example, the environment 900 can be part of a computing platform configured to provide a variety of services to users, through various user interfaces and/or APIs exposing the platform services. The user computing device 912 may receive and transmit data specifying target computing resources to be allocated for executing a neural network trained to perform a particular neural network task.

The devices 912, 915 can be capable of direct and indirect communication over the network 960. The devices 915, 912 can set up listening sockets that may accept an initiating connection for sending and receiving information. The network 960 itself can include various configurations and protocols including the Internet, World Wide Web, intranets, virtual private networks, wide area networks, local networks, and private networks using communication protocols proprietary to one or more companies. The network 960 can support a variety of short- and long-range connections. The short- and long-range connections may be made over different bandwidths, such as 2.402 GHz to 2.480 GHz (commonly associated with the Bluetooth® standard), 2.4 GHz and 5 GHz (commonly associated with the Wi-Fi® communication protocol); or with a variety of communication standards, such as the LTE® standard for wireless broadband communication. The network 960, in addition or alternatively, can also support wired connections between the devices 912, 915, including over various types of Ethernet connection.

Although a single server computing device 915 and user computing device 912 are shown in FIG. 9, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

Aspects of this disclosure can be implemented in digital circuits, computer-readable storage media, as one or more computer programs, or a combination of one or more of the foregoing. The computer-readable storage media can be non-transitory, e.g., as one or more instructions executable by a cloud computing platform and stored on a tangible storage device.

In this specification the phrase “configured to” is used in different contexts related to computer systems, hardware, or part of a computer program, engine, or module. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program, engine, or module is said to be configured to perform one or more operations, this means that the computer program includes one or more program instructions, that when executed by one or more computers, causes the one or more computers to perform the one or more operations.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for identifying domain expert videos, the method comprising:
tagging, by one or more processors, data corresponding to the viewing of a video by a user;
determining, by the one or more processors, that the user has satisfied a set of predefined events, based at least partly on the tagged data;
after determining the user has satisfied the set of predefined events, associating the tagged data with a domain expert associated with the video;
processing, by the one or more processors, the tagged data through a reasoning system to determine a set of weighted outcomes; and
updating, by the one or more processors, a ranking list of domain expert videos based on the set of weighted outcomes.

2. The method of claim 1, wherein the ranking list of domain expert videos is updated using a recurrent neural network trained to apply a take-the-best heuristic.

3. The method of claim 1, wherein the set of predefined events comprises one or more of:
the use of a bot filter while the user watches the video;
the tagged video viewed to completion or not viewed to completion by the user;
audio on while video viewed to completion, or if video watched with audio muted;
verifying viewer identity;
verifying viewer legal drinking age; and
a time/date stamped signature from the tagged video.

4. The method of claim 1, wherein determining that the user has satisfied the set of predetermined events comprises binning values corresponding to the set of predetermined events through one or more fuzzy sets, each fuzzy set corresponding to a linguistic variable.

5. The method of claim 4, wherein processing the tagged data comprises processing the data binned values through a fuzzy controller comprising one or more knowledge bases to determine the set of weighted outcomes.

6. The method of claim 5, wherein each knowledge base corresponds to a respective domain, the tagged video corresponding to a domain.

7. The method of claim 1, further comprising:
serving videos in response to a user request, wherein the videos served are in an order based on the updated ranking.

8. The method of claim 1, further comprising:
measuring, by some measurement module, user interaction to determine for a plurality of events whether the events have occurred in the interaction of the user with the platform before, during and/or after the video is served, where a certain event corresponds to a certain type of user interaction,
depending on the measurement result, determining for each measured user interaction a value assigned to a tag corresponding to the measured user interaction, wherein the value corresponding to a certain event is indicative of a partial degree of user interaction, wherein for non-binary measurement results the result of an interaction is binned into a set of fuzzy variables, the measurement results including a plurality of non-binary measurement results;
feeding the tag values resulting from the measurement results to the reasoning system to determine a weighted outcome indicative of the overall degree of user interaction based on the combination of the tag values each representing a partial degree of user interaction;
ranking a list of domain expert videos based on the resulting weighted outcomes of the respective videos; and
updating the ranked list using a recurrent neural network trained to apply a take-the-best heuristic.

9. A system for identifying domain expert videos,
the system comprising one or more processors configured to:
tag data corresponding to the viewing of a video by a user;
determine that the user has satisfied a set of predefined events, based at least partly on the tagged data;
after the determination that the user has satisfied the set of predefined events, associate the tagged data with a domain expert associated with the video;
process the tagged data through a reasoning system to determine a set of weighted outcomes; and
update a ranking list of domain expert videos based on the set of weighted outcomes.

10. The system of claim 9, wherein the ranking list of domain expert videos is updated using a recurrent neural network trained to apply a take-the-best heuristic.

11. The system of claim 9, wherein the set of predefined events comprises one or more of:
the use of a bot filter while the user watches the video;
the tagged video viewed to completion or not viewed to completion by the user;
audio on while video viewed to completion, or if video watched with audio muted;
verifying viewer identity;
verifying viewer legal drinking age; and
a time/date stamped signature from the tagged video.

12. The system of claim 9, wherein in determining that the user has satisfied the set of predetermined events, the one or more processors are configured to bin values corresponding to the set of predetermined events through one or more fuzzy sets, each fuzzy set corresponding to a linguistic variable.

13. The system of claim 12, wherein in processing the tagged data, the one or more processors are configured to process the data binned values through a fuzzy controller comprising one or more knowledge bases to determine the set of weighted outcomes.

14. The system of claim 13, wherein each knowledge base corresponds to a respective domain, the tagged video corresponding to a domain.

15. The system of claim 9, wherein the one or more processors are further configured to:
serve videos in response to a user request, wherein the videos served are in an order based on the updated ranking.

16. The system of claim 9, wherein the one or more processors are further configured to:
measure, by some measurement module, user interaction to determine for a plurality of events whether the events have occurred in the interaction of the user with the platform before, during and/or after the video is served, where a certain event corresponds to a certain type of user interaction,
depending on the measurement result, determine for each measured user interaction a value assigned to a tag corresponding to the measured user interaction, wherein the value corresponding to a certain event is indicative of a partial degree of user interaction, wherein for non-binary measurement results the result of an interaction is binned into a set of fuzzy variables, the measurement results including a plurality of non-binary measurement results;
feed the tag values resulting from the measurement results to the reasoning system to determine a weighted outcome indicative of the overall degree of user interaction based on the combination of the tag values each representing a partial degree of user interaction;
rank a list of domain expert videos based on the resulting weighted outcomes of the respective videos; and
update the ranked list using a recurrent neural network trained to apply a take-the-best heuristic.

17. One or more computer-readable storage media storing instructions, that when executed by one or more processors, cause the one or more processors to perform operations comprising:
tagging, by one or more processors, data corresponding to the viewing of a video by a user;
determining, by the one or more processors, that the user has satisfied a set of predefined events, based at least partly on the tagged data;
after determining the user has satisfied the set of predefined events, associating the tagged data with a domain expert associated with the video;
processing, by the one or more processors, the tagged data through a reasoning system to determine a set of weighted outcomes; and
updating, by the one or more processors, a ranking list of domain expert videos based on the set of weighted outcomes.

18. The computer-readable storage media of claim 17, wherein determining that the user has satisfied the set of predetermined events comprises binning values corresponding to the set of predetermined events through one or more fuzzy sets, each fuzzy set corresponding to a linguistic variable.

19. The computer-readable storage media of claim 18, wherein processing the tagged data comprises processing the data binned values through a fuzzy controller comprising one or more knowledge bases to determine the set of weighted outcomes.

20. The computer-readable storage media of claim 17, wherein the operations further comprise:
measuring, by some measurement module, user interaction to determine for a plurality of events whether the events have occurred in the interaction of the user with the platform before, during and/or after the video is served, where a certain event corresponds to a certain type of user interaction,
depending on the measurement result, determining for each measured user interaction a value assigned to a tag corresponding to the measured user interaction, wherein the value corresponding to a certain event is indicative of a partial degree of user interaction, wherein for non-binary measurement results the result of an interaction is binned into a set of fuzzy variables, the measurement results including a plurality of non-binary measurement results;
feeding the tag values resulting from the measurement results to the reasoning system to determine a weighted outcome indicative of the overall degree of user interaction based on the combination of the tag values each representing a partial degree of user interaction;
ranking a list of domain expert videos based on the resulting weighted outcomes of the respective videos; and
updating the ranked list using a recurrent neural network trained to apply a take-the-best heuristic.
